(19) United States
(12) Patent Application Publication
(10) Pub. No.: US 2009/0117939 A1
(43) Pub. Date: May 7, 2009

(54) METHODS AND ARRANGEMENT FOR CONDUCTING TELEPHONE CONVERSATIONS ON SEVERAL MOBILE PHONE NETWORKS

(76) Inventor: Stefan Asthoff, Dusseldorf (DE)

Correspondence Address: K.F. ROSS P.C., 5683 RIVERDALE AVENUE, SUITE 203 BOX 900, BRONX, NY, 10471-0900, US

(21) Appl. No.: 12/296,113

(22) PCT Filed: Apr. 3, 2007
(86) PCT No.: PCT/DE07/00604

§ 371 Date: Oct. 6, 2008

(30) Foreign Application Priority Data
Apr. 11, 2006 (DE) 10 2006 017 364.3

(51) Int. Cl. H04W 88/06

(52) U.S. Cl. 455/552.1

(57) ABSTRACT

A mobile radio (1) has a housing (2) with a recess (15) which is associated with the housing rear face (11) for a specific SIM card (12). Furthermore, however, this rear face has further associated recesses (18) in which further SIM cards (12, 12′, 12′, 12″, 12″) can be inserted in order in this way to provide the user with the capability to dial into specific radio networks, which allow network-internal calls, by activating or addressing the appropriate SIM cards (12). IC charges and the like are thus no longer incurred, with further operational reliability advantages also being provided.

The invention relates to a method of conducting telephone conversations on several mobile phone networks from a mobile phone, whereby a permanent network connection is established and maintained via the mobile phone and the integrated STM card. The invention also relates to an arrangement comprising a mobile phone with keypad, SIM card and usual circuitry, whereby the SIM card can be fitted into a recess with contacts which is provided on the back and a permanent connection with the assigned mobile phone network can be established via the circuits and via the SIM card.

Methods, and mobile phones which function accordingly, are known with which, without special measures and above all without incurring special charges, it is possible to conduct telephone conversations with a wide range of subscribers within a particular mobile phone network. However, as soon as a subscriber wishes to call, or calls, a subscriber who is using a different mobile phone network or who will be using a different mobile phone network, so-called IC charges are charged that the network operators or owners charge each other when calls are made from one mobile phone network to another. The resulting additional charges are considerable, these charges being even higher if a caller needs to be connected with foreign networks. Whether there arc reasons for these charges is immaterial, in any case so-called mobile phone service providers also have to levy such charges and pass these on to the respective mobile phone network operator. These mobile phone service providers can sell the relevant network operator's SIM cards on behalf of the mobile phone network operators and charge the callers corresponding charges. In addition to the additional costs incurred in making calls between different networks, it is a disadvantage that the individual mobile phone network operators in some cases charge different costs, whereby the customer is tied to such a network operator once a contract has been signed. They no longer have the right to choose.

The invention is based on the problem of creating a method and a device that make it possible to conduct telephone conversations on several mobile phone networks as well as conducting telephone conversations within a network using only a single mobile phone, i.e. without incurring separate charges.

In terms of the method, the problem is solved in that several SIM cards integrated into a mobile phone are activated in parallel so as to maintain their respective network connection and so as to establish the parallel network connection via the allocated dialing codes (dialing blocks).

With the aid of such a method it is thus possible, using a single mobile phone, to make calls within different networks, i.e within the network to which the other party is connected. As a result, no IC charges are incurred because the same mobile phone is used to make a call within the same mobile phone network used by the other party. These in-network calls are, for example, currently charged at a rate of 5 cents, whereas costs that are 300 to 400% higher would be incurred if IC charges were charged. It is also advantageous that with such a method or mobile phone, the ability to reach the respective network customer is guaranteed, because the user can select the mobile phone network that they need to use so that the call takes place on a network where they can talk with a parallel telephone user in an optimal network. They have numerous dialing options, so that overall, a significantly better exploitation of the available overall technology is possible. Moreover, the psychological effect and convenience of always being able to make and receive calls economically is also certainly important. The other party naturally has the same advantage, since they can call their friend via their own network, so that the other party also enjoys the benefit of making an in-network and thus economical call. For practical purposes, the calls are charged via corresponding mobile phone service providers, who can in any case supply the corresponding SIM cards, whereby the mobile phone user only receives one bill for the use of several mobile phone networks. Also conceivable is the use of SIM cards of the different network operators acquired independently of one another, whereby the advantage of only one bill per user is lost, though a considerable potential for savings still exists.

According to the invention it is particularly practical if the parallel network connections are identified on the basis of the dialing codes or another, or additional, network-allocating characteristic. It is certainly thereby advantageous if several characteristics are taken into account in order to wholly rule out wrong network connections from the outset.

According to a further variant of the method it is proposed that the parallel network connections are selected via the SIM card or an alternative network-allocating storage medium. Here too, reliability is the key aspect that distinguishes such a method.

In order to carry out the method, a device is provided in which the housing of the mobile phone contains a plurality of integrated SIM cards belonging to the mobile phone networks in question, which establish and maintain a permanent connection with the mobile phone network allocated to them, and a transmitter that addresses the SIM card associated with the dialing code that has been dialed and establishes the connection is connected between the keypad with the number keys and the SIM cards. In a mobile phone of such design, full use can be made of the existing technology, i.e. a mobile phone of approximately usual construction type is used to which a plurality of SIM cards can simply be fitted and that can at the same time receive calls from a plurality of mobile phone networks. The user can thereby decide for themselves how many SIM cards and how many network connections they wish to have in order to be able to make calls to their friends, or whoever, cheaply, quickly and reliably. This design of mobile phone and SIM cards, together with the circuits, ensures that a connection to the intended mobile phone network is guaranteed, so that naturally it is possible at all times to receive calls from third parties, as well as making calls within the desired mobile phone network. On dialing or being dialed, the respective dialing code and thus the desired mobile phone network is recognized via the transmitter and is then activated within the mobile phone so that outgoing and incoming calls can take place.

in order to make sure that incoming calls are also received and stored appropriately and cheaply in the absence of the user, according to the invention the transmitter is designed to direct the incoming calls to the call memories allocated to the networks. The transmitter also ensures that an incoming call is assigned to the call memory assigned to the relevant mobile phone network. Naturally, it is also conceivable to design and equip the transmitter in such a way that a single call memory can be used, whereby the transmitter informs the “mobile phone network” that the incoming call has been logged correctly and in the existing mobile phone network call memory.

It has already been pointed out that use can substantially be made of existing technology, i.e. corresponding mobile phones, with a plurality of SIM cards simply needing to be integrated. This is achieved most simply and reliably if a plurality of integrated slots for SIM cards are provided on the back of the phone, into which the SIM cards can then be fitted in order to activate both incoming and outgoing traffic. If, for example, the slot provided for a particular mobile phone network or, rather, the corresponding SIM card, is not in use, then the transmitter cannot recognize or assign anything so that, for example, a negative message would be communicated to the caller, as is usual at present where mobile phones are switched off or SIM cards not fitted. In this case the caller is either obliged to switch to a different mobile phone network or otherwise establish contact with the person they wish to call. Naturally, charges are made for STM cards and thus for the occupancy of a particular mobile phone network, but in contrast to IC charges these are clearly comprehensible so that, as a rule, if necessary a user can also use four or more SIM cards in order to enjoy the other price advantages and also technical advantages associated with the use of several SIM cards.

In order to allow the user as many dialing options as possible, according to the invention the contacts allocated to the slots are designed so as to be activated when a SIM card is fitted. This provides the user with the possibility of using a correspondingly-assigned SIM card or of disregarding a particular mobile phone network if, for example, they have no contacts using that network. They can thus equip and utilize their mobile phone according to their needs.

In order to increase the number of SIM cards used, or to further reduce the number of modifications required, according to the invention a sunken recess with contacts that receives several SIM cards arranged above one another is provided on the back of the phone. In addition to the possibility of arranging several SIM cards next to one another on the same plane, the possibility is provided here of arranging them on top of one another, in order to provide the user with the possibility of using a practically unmodified mobile phone that is simply less complex in terms of connections than a basic mobile phone. It is thus suggested here that the user be given the possibility of using a practically unmodified mobile phone that is simply less complex in terms of connections than a basic mobile phone. The SIM cards are combined into a block and, depending on their number and arrangement, can be activated and thus utilized by fitting them into the corresponding sunken recess. With this design too, not all of the SIM card slots need to be occupied; rather, the user has the possibility of using and fitting the SIM cards for the mobile phone networks in which they are interested.

If the necessary contacts are positioned on the side walls of the recess and the contacts on the SIM cards are arranged and designed correspondingly, it is practical for the required SIM cards to be activated on fitting the corresponding SIM card block into the sunken recess. This means the user does not need to take any particular care; they simply slide the block with the chosen SIM cards into the recess and are able to make calls immediately. This solution too—as described above—also allows simple assembly and rapid activation of the device, whereby the contacts provided on the side walls are perhaps simpler than contacts that need to be slotted into the intermediate spaces, though the latter solution has the advantage that existing SIM cards can be used, whereas with contacts arranged on the sides the SIM cards also need to be modified accordingly.

In the embodiment described above, the transmitter will, both with outgoing calls and incoming calls, recognize the dialing codes used and thus address and activate the corresponding SIM cards. Since the corresponding mobile phone networks use four digits, i.e. particular dialing code blocks, it is practical and relatively simple to establish corresponding connections when a transmitter installed between the keypad and SIM cards is designed and connected so as to recognize defined dialing code blocks and establish a connection to the associated SIM card. It is hereby possible that either the last digit of the code, or the dialing code block as a whole, is the decisive characteristic for the dialing code block; in any case the transmitter is to be configured in such a way that it first of all only registers and processes the first four digits before it then further processes the dialed telephone number and thus dials into and connects with the corresponding mobile phone network.

For the user, it is initially not even apparent which mobile phone network their mobile phone is connecting with. Since they wish to know this beforehand and, moreover, check whether the phone has dialed correctly or whether they have entered the correct dialing code block, it is of advantage if, on the front of the phone, next to the keypad, the display and the other function keys, network keys are provided that are designed as illuminating keys that light up when the respective mobile phone networks respond. If, for example, the D1 mobile phone network is dialed, then the corresponding illuminating key or network key lights up and the user knows that they have dialed correctly and that they are on the right mobile phone network. This has psychological advantages, but also helps prevent misdialing and wrong connections, because when a wrong network key lights up the user can very quickly break off the call, before costs are incurred.

According to a further development of the invention it is proposed that the network keys are designed, in the event of failure of the transmitter, or if the user wishes to by-pass the transmitter, to be switched and establish the connection with the selected SIM card. The transmitter can then be circumvented with the aid of the network keys without the mobile phone immediately failing and no longer being usable. The user can thus manage by themselves for a certain time, with the further advantage that they do not need to enter the entire dialing code, but simply need to activate the relevant dialing code block.

As an alternative to the illuminated network keys, a visualization of the mobile phone network currently being used is provided via the display featured on every mobile phone. Manual network selection, by-passing the transmitter, can also, alternatively, be achieved using a menu on the display using the function keys provided, in order to minimize as far as possible the necessary modifications of existing and future models of mobile phone.

It is not inconceivable that new mobile phone networks will be added or that when using the mobile phone abroad, the user will wish to activate additional mobile phone networks. This is possible without any problem, because according to the invention the transmitter is designed to be adjustable in terms of the dialing code blocks that it recognizes. Apart from the set dialing code blocks with which it is “familiar,” the transmitter can thus be supplied with supplementary dialing code blocks, or the dialing code blocks can be replaced, depending on how many SIM cards are in use. If a SIM card slot is still free, then with the corresponding dialing code block set in the transmitter, the further procedure as described above can be achieved simply and reliably.

According to a further development of the invention, four SIM cards, or a plurality of SIM cards, do not always need to be used; rather, a combination SIM card can be installed in the housing of the mobile phone that is designed to take over the function of the SIM cards assigned to the other mobile phone networks. A single SIM card thus displays all the functions and identifying features required for all network operators, so that a single SIM card can be used.

A further possibility of this method of operating a mobile phone is that in which one of several SIM cards of other mobile phone networks stored in the associated fixed network connection with routing box is addressed via the SIM card and by dialing one of the associated fixed network numbers, via which the connection to the desired in-network call is then established via the first SIM card. This makes it possible to dial a fixed network number with a SIM card mobile phone, whereby one of the three SIM cards stored in the so-called routing box is activated, so that the other party is dialed by the corresponding SIM card and an in-network call takes place. The possibility of combining several such SIM cards into a unit has thus been extended from the mobile phone to the fixed network telephone, namely to the so-called routing box. Thus, this does not activate a fixed-network-to-mobile call, but as before a mobile-to-mobile call on the same network. This leads—as described with reference to the four SIM card device—to significantly more economical charges, since the IC charges do not apply. This solution is a variant that does not take into consideration the construction of the corresponding four SIM card mobile phone, so that mobile phones previously used on the market can also be used to make economical calls. This external variant contains all the technical solutions relevant to the invention, which through the described intermediate step, namely dialing the external transmitter, contains all the advantages of the four SIM card mobile phone. All technically feasible solutions are thus used here in order to reduce costs for the end user.

An arrangement is used for this purpose in which several SIM cards belonging to other mobile phone networks are stored in the routing box of the relevant fixed network connection, which via a transmitter that can be activated by the fixed network connection can be specifically addressed and activated so as to establish a connection to the first Sim card. As already mentioned, this thus makes it possible to use the fixed network connection simply as a SIM card storage unit while, as before, using the associated mobile phone to make the corresponding calls.

The invention is characterized in particular in that with the aid of the method in accordance with the invention and the mobile phone or arrangement in accordance with the invention, calls can be conducted on different mobile phone networks using the same mobile phone, without so-called IC charges or other special charges being incurred, because through the described switching and design of the mobile phone it is ensured that the user talks with the other party on the same mobile phone network. Calls are made as in-network calls, which means that only the relatively low charges of this network are incurred, with the user being able without any problem to select for their calls the mobile phone network used by the other party or that offers advantages in terms of costs. The savings for the customer are considerable, because as a rule IC charges are 300 to 400% higher than in-network call charges and account for a large part of mobile phone bills. Frequently, the user is not aware beforehand that they are incurring significantly higher charges when they make calls from their network into another. According to the invention it is also possible, by means of a flashing light or similar, to alert the user to the fact that they are changing networks. They can then decide for themselves whether to go ahead or cancel the call, so that they can enjoy maximum advantages if they use such a mobile phone with 4-SIM technology or multi-SIM technology.

A further advantage is that they can expect a virtually 100% network coverage and 100% accessibility because they can use the most economical of the mobile phone networks available to them both to make and receive calls. The caller thereby also enjoys the advantage that they are in effect making an in-network call, without incurring special IC charges or similar. There are four mobile phone network operators in the Federal Republic of Germany, who have designated their networks D1, D2, E and 0₂.

Further details and advantages of the subject matter of the invention are explained in the following descriptions of the drawings that show a preferred embodiment with the necessary details and individual components.

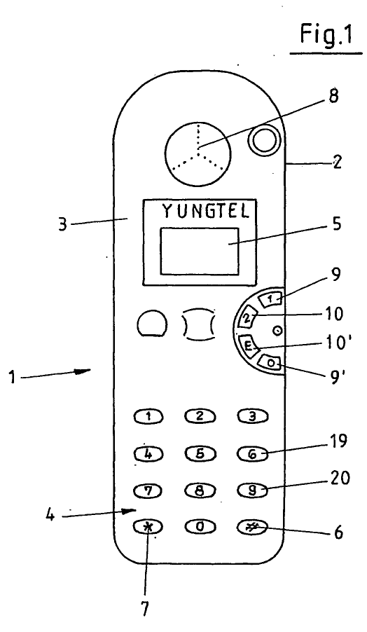

FIG. 1 shows a mobile phone, viewed from the front,

FIG. 2 shows a mobile phone, viewed from the back,

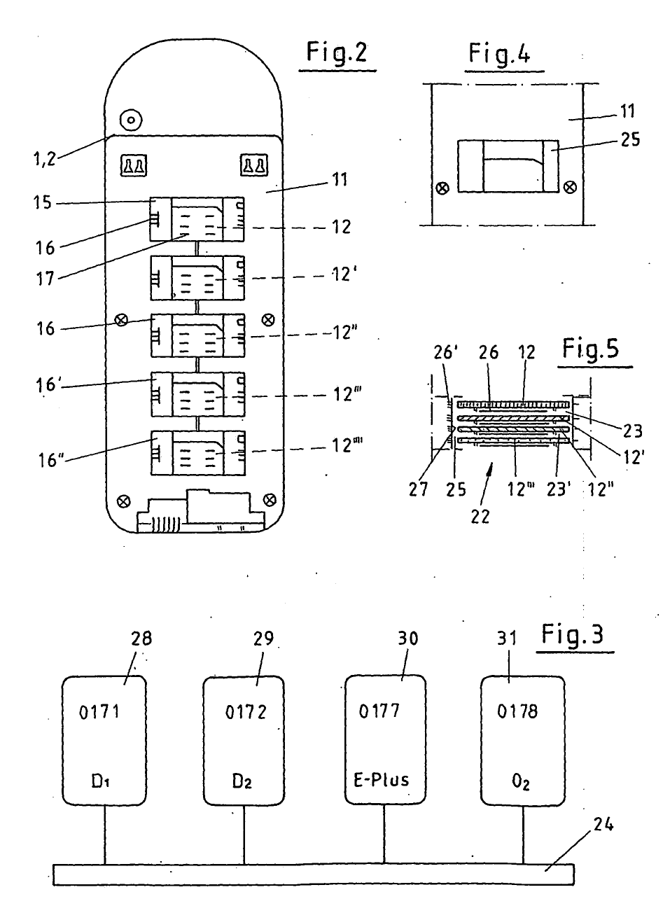

FIG. 3 is a diagrammatic representation of the connection between the transmitter and dialing code block segments,

FIG. 4 shows a partial view of the back of a mobile phone with sunken recess accommodating a plurality of SIM cards and

FIG. 5 shows a section through the mobile phone in the area of the sunken recess with the SIM cards fitted.

The mobile phone 1 shown in FIG. 1 is a conventional mobile phone, known in German as a “Handy,” whereby it can be seen from the housing 2 that this is an older model. The keypad 4 and display 5 can be seen on the front side 3 of the phone. A hash key and an asterisk key are used as function keys 6 and 7, as is usual with mobile phones today. The earpiece is identified with 8. In departure from usual mobile phones, a plurality of network keys 9, 9′ and 10, 10′ are shown at the side, with the network key 9 being marked with the number 1, the network key 10 with the number 2, the network key 10′ with E and the network key 9′ with 0, to make it clearly recognizable to which mobile phone network the respective network keys 9, 9′ 10 and 10′ relate.

The number keys are marked 19 and 20, i.e. the keys that are required in order to enter the desired telephone number.

On the back 11 of the phone, SIM cards 12, 12′, 12″, 12″′, 12″″ are indicated, although only the slots 15, 18 accommodating these can be seen. According to the representation in FIG. 2 then, five different SIM cards 12, 12′, 12″, 12″′, 12″″ can be fitted, whereby properly speaking the representation in FIG. 2 shows the condition in which no SIM cards ate in use. The slots are all prepared accordingly and pre-equipped, so that when an assigned SIM card 12 is inserted the contacts 16, 17 ensure that the circuits are activated and corresponding calls can take place if desired.

FIG. 3 shows a simplified representation of a circuit, whereby the transmitter is identified with 24. It is connected with the dialing code blocks 28, 29, 30, 31 so that it can be activated very quickly and simply, both with incoming and outgoing calls, in order to assign the call to the desired mobile phone network or SIM card. It should be taken into consideration here that the individual dialing code blocks 28 to 31 identify the corresponding mobile phone networks and make possible a connection with and from these, by activating the transmitter 24.

FIGS. 4 and 5 show a particular embodiment in which, instead of the plurality of slots 15, 18, only one sunken recess 25 is provided, on the back 11 of the phone. A block 24 of several SIM cards can be fitted into this recess 25, whereby as shown in FIG. 5 contacts 26 are arranged in the intervening space 23 between the individual STM cards 12, 12′, 12″, 12″′, 121″″ that provide the connection with the actual mobile phone 1. However, it is also indicated in the same FIG. 5 that these contacts 26′ can be arranged on the side wall or side walls 27 of the recessed slot, or also additionally, whereby naturally both the contacts 26 and also the SIM cards need to be matched to one another, so that the SIM cards need to be modified. Otherwise, commercially available SIM cards can be used.

The network keys 9, 9′, 10, 10′ are arranged and designed such that when pressed a contact is established which then ensures that, circumventing, or also activating, the transmitter 24, the assigned mobile phone network is activated or addressed. Above all however, these network keys 9, 9′, 10, 10′ are designed as illuminating keys, so that the user of such a mobile phone 1 immediately recognizes which mobile phone network or which of the dialing code blocks 28, 29, 30, 31 is being addressed when they have entered a particular dialing code using the number keys 19, 20, The described design of the mobile phone 1 makes it clear that numerous possibilities for use are provided, but above all one in which the IC charges are as a rule no longer incurred if the mobile phone has been operated correctly.

All of the features mentioned, including those only indicated in the drawings, are regarded individually and in combination as being important aspects of the invention.

1. A method of conducting telephone conversations on a plurality of mobile phone networks from a mobile phone whereby, using the mobile phone and a plurality of SIM cards integrated into the mobile phone, their respective network connections are established and maintained in parallel, wherein the SIM cards are assigned to different mobile phone networks and that the SIM card assigned to the dialing code block is addressed and its parallel network connection activated via a transmitter that is connected between the keypad of the mobile phone with the number keys and the SIM cards, which recognizes the dialing code block used when dialing, and thus the desired mobile phone network.

2. The method according to claim 1 wherein the transmitter first registers and processes the first four digits before it further processes the dialed telephone number and then therefore dials into the mobile phone network identified by the dialing code block.

3. An arrangement for carrying out the method according to claim 1, the arrangement comprising a mobile phone with keypad, SIM card and usual circuitry, whereby the SIM card can be fitted into a slot on the back of the phone featuring contacts and a permanent connection with the assigned mobile phone network can be established via the circuits and via the SIM card, and whereby the housing of the mobile phone contains a plurality of integrated SIM cards that are designed and connected so as to establish and maintain a permanent connection with the mobile phone network assigned to them wherein a transmitter is connected between the keypad with the number keys and the SIM cards by means of which the dialing code block and the mobile phone network identified by this can be recognized and with which the SIM card assigned to the dialed dialing code block can be activated.

4. The arrangement according to claim 3 wherein the transmitter is designed so as to route incoming calls to the call memories assigned to the respective networks.

5. The arrangement according to claim 3 wherein a plurality of integrated slots for SIM cards are provided on the back of the phone.

6. The arrangement according to claim 5 wherein the contacts assigned to the slots are designed so as to be activated on insertion of a SIM card.

7. The arrangement according to claim 3 wherein a sunken recess with contacts accommodating a plurality of SIM cards arranged on top of one another is provided on the back of the phone.

8. The arrangement according to claim 3 wherein the SIM cards are arranged on top of one another forming a block, whereby the contacts are designed so as to slot into the intervening spaces between the SIM cards.

9. The arrangement according to claim 3 wherein the contacts are arranged on the side walls of the sunken recess and are arranged and designed so as to correspond with the contacts of the SIM cards.

10. The arrangement according to claim 3 wherein, on the front side of the phone, in addition to the keypad, the display and the other function keys, network keys are provided that are designed as illuminating keys that light up when the relevant mobile phone network is addressed.

11. The arrangement according to claim 3 wherein, in the event of failure of the transmitter, the network keys are designed to be activated so as to establish the connection with the dialed SIM card.

12. The arrangement according to claim 3 wherein the transmitter is designed so as to be adjustable with respect to the dialing code blocks that are to be recognized.

13. The arrangement according to claim 3 wherein the housing of the mobile phone contains a combination SIM card that is designed to take on the function of the SIM cards assigned to the other mobile phone networks.
